(19) United States
(12) Patent Application Publication
(10) Pub. No.: US 2017/0136647 A1
(43) Pub. Date: May 18, 2017

(54) APPARATUS FOR PROCESSING, IN PARTICULAR FOR CUTTING A CORRESPONDING MATERIAL

(71) Applicant: BIERREBI ITALIA S.R.L., Sasso Marconi (Bologna) (IT)

(72) Inventors: Paolo TEDESCHI, Monzuno (IT); Mauro DE GENNARO, San Lazzaro di Savena (IT)

(21) Appl. No.: 15/317,146

(22) PCT Filed: Jun. 11, 2015
(86) PCT No.: PCT/IB2015/054428

§ 371 Date: Dec. 8, 2016

(30) Foreign Application Priority Data
Jun. 13, 2014 (IT) BO2014A000334

(51) Int. Cl. B26D 7/01; B26D 5/00; D06H 7/24; B26F 1/38

(52) U.S. Cl. CPC B26D 7/015; B26F 1/3826; B26D 5/005; D06H 7/24

(57) ABSTRACT

Described is an apparatus (10) for processing, in particular for cutting, a material (11), the material preferably including a respective layer, especially in tape- or band-like form and preferably in the form of fabric or the like for making corresponding pieces for clothing, that is, for garments, apparel, or the like; the apparatus has a respective surface (12) for supporting, in particular for resting, the material and, preferably, elements for cutting the material on the supporting surface (12). The apparatus also includes elements designed to generate a field of electrostatic attraction of the material (11) on the supporting surface (12).

### TECHNICAL FIELD

This invention relates to an apparatus for processing, in particular for cutting a corresponding material.

The material preferably comprises a respective layer, especially in tape- or band-like form, preferably in the form of a fabric or the like, and especially used for making corresponding pieces of clothing, that is, for garments, apparel, or the like.

### BACKGROUND ART

There are prior art apparatuses for cutting a fabric or the like, especially for making corresponding pieces of clothing, that is, garments, apparel, or the like, the apparatuses having a respective supporting surface, in particular for supporting the material, and means for cutting the material on the supporting surface, in particular in the form of a respective blade for cutting the material on the supporting surface.

In the sector of cutting fabrics for garments in general, a problem particularly felt concerns the inability of these prior art machines to keep the fabric to be cut perfectly still during the cutting of the fabric, that is to say, more specifically, perfectly flat. Therefore, with the use of prior art cutting apparatuses, it is not possible to obtain pieces for corresponding items of clothing which have optimum and desired dimensions and workmanship.

More specifically, according to the prior art, suction means are normally used in order to keep the fabric adhering to the supporting surface, sucking the material onto the supporting surface, thanks also to the application of an outer layer of plastic film. However, this mode of adhesion of the fabric to the supporting surface results in a significant energy consumption and the use of excessive material for making the outer plastic film, without, however, being able to retain in an optimum or homogeneous fashion the material to be cut along the entire and corresponding surface, with the consequent achievement of pieces for garments which do not have optimum and desired dimensions and workmanship.

Alternatively, according to another prior art cutting technique, the material is retained by mans of a pair of presser rollers which slide on the same material and between which there are corresponding cutting means.

However, also in this case, the retaining of the material on the respective supporting surface is not optimum.

The field also feels the need for an apparatus for processing, in particular for cutting a material, which allows an efficient cutting operation to be performed and which has a relatively low construction cost.

### AIM OF THE INVENTION

This invention proposes a novel solution, alternative to the solutions known up to now and which can overcome one or more of the above mentioned disadvantages and/or meet one or more of the requirements mentioned in or inferable from the above.

It is accordingly provided an apparatus for processing, in particular for cutting, a material, the material preferably comprising a respective layer, especially in tape- or band-like form, preferably in the form of fabric or the like, and being especially for making corresponding pieces for clothing, that is, for garments, apparel, or the like; the apparatus having a respective surface for supporting, in particular for resting, the material and, preferably, means for cutting the material, in particular located on the supporting surface; the apparatus being characterised in that it comprises means designed to generate a field of electrostatic attraction of the material on the supporting surface.

In this way, it is possible to obtain a particularly effective stationary retaining of the material on the supporting surface, and in particular on the surface on which the material is cut, thus obtaining an optimum processing of the material, in particular, pieces cut with optimum and desired workmanship.

### BRIEF DESCRIPTION OF THE DRAWINGS

These and other innovative aspects of the apparatus, or specific advantageous embodiments, are set out in the appended claims and its technical features and advantages are apparent from the detailed description which follows of a preferred, advantageous embodiment of it, which must be considered purely as a non-limiting example. the description being made with reference to the accompanying drawings, in which:

FIG. 1 is a perspective schematic view of a preferred embodiment of the apparatus according to this invention;

FIG. 2 is a schematic side view of a detail of the preferred embodiment of the apparatus according to this invention;

FIGS. 3A to 3D illustrate different steps which allow the generation of a field of electrostatic attraction of the material on the supporting surface of the same material in the preferred embodiment of the apparatus according to this invention.

### DETAILED DESCRIPTION OF PREFERRED EMBODIMENTS OF THE INVENTION

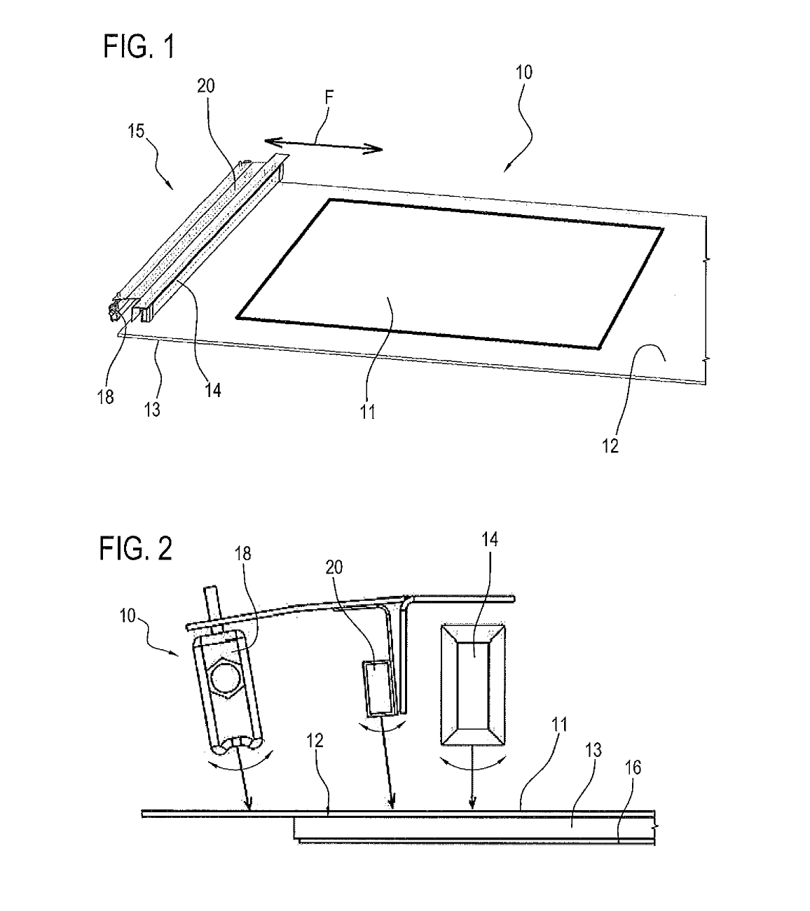

FIGS. 1 and 2 illustrate a preferred embodiment 10 of an apparatus for processing a material 11, in particular for cutting the material 11 into a plurality of pieces, preferably used for making respective items of clothing, that is, garments, apparel, or the like.

The material comprises a respective layer, especially in a tape- or band-like form, in particular made of fabric or the like and, possibly, a secondary layer, preferably in the form of a respective sheet, especially made of paper material, in particular of paper, which is in particular designed for tracing lines for defining corresponding shapes, or shaped profiles, defining respective pieces of clothing and/or corresponding alphanumeric writing or the like for identifying the corresponding pieces.

The secondary layer of material is positioned above the primary layer, and in particular is intended to be cut together with the primary layer.

As may be inferred from FIGS. 1 and 2, the apparatus comprises a respective surface 12 for supporting, in particular for resting, the material 11, at a respective processing zone, in particular for cutting the material.

As illustrated, the supporting surface is preferably in the form of a flat surface 12.

This preferred embodiment of the apparatus 10 also comprises means for cutting the material, preferably at the supporting surface 12, that is, resting on the supporting surface 12.

These cutting means are not illustrated in detail in the accompanying drawings and might also be made as shown in international patent application WO2010/073269, which is in the name of the same applicant, the description in that patent being incorporated herein by reference.

Preferably, the cutting means are in the form of corresponding circular blade means, in particular which cut the material engaging against the underlying supporting surface 12, the cutting means being supported by a corresponding head, or movable unit, 15, preferably along the supporting surface 12 and along the material 11, supported on this. In practice, the cutting means move transversely to the head defining corresponding cutting trajectories or simply movement according to respective coordinates which are longitudinal and transversal to the apparatus or supporting surface.

Advantageously, the apparatus according to the invention comprises means designed to generate a field of electrostatic attraction of the material 11 on the supporting surface 12.

Advantageously, the means designed to generate a field of electrostatic attraction of the material 11 on the supporting surface 12 are in the form of means which can be activated and deactivated, in particular using corresponding electronic control means, preferably comprising computerised means for controlling the apparatus for processing or cutting the material.

Advantageously, the means designed to generate a field of electrostatic attraction of the material 11 on the supporting surface 12 comprise means designed to apply, or to induce, electrical charges on the material 11.

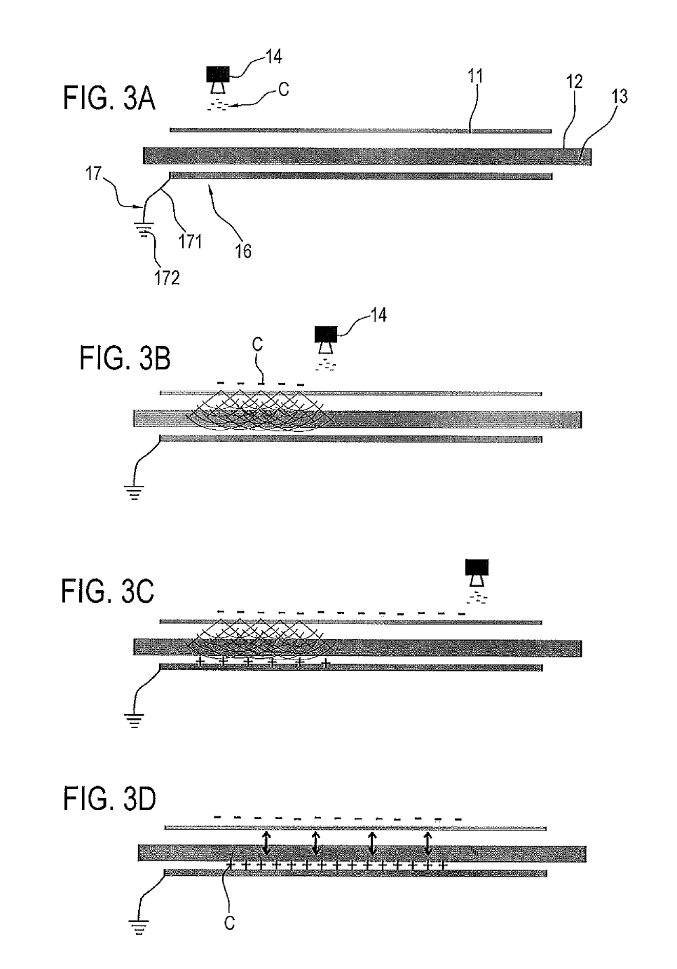

More specifically, the electrical charges may be in the form of positive or negative electrical charges, and preferably in the form of negative electrical charges, as illustrated in FIGS. 3A to 3D.

Advantageously, the means designed to generate a field of electrostatic attraction of the material on the supporting surface 12 are in the form of means designed to induce a homogeneous distribution of electrical charges on the material 11.

More specifically, the means designed to induce the electrical charges on the material comprise means 14 for emitting electrical charges or ionizing means.

Further advantageously, the means for emitting electrical charges comprise a respective elongate ionizing bar 14, in particular elongate transversely to the longitudinal direction of extension of the supporting surface 12 and of extension of the material 11 to be processed.

Advantageously, the electrical charges are applied at the outer face of the material 11, namely, on the face of the material which is opposite the face resting on the surface 12 for supporting the material, as may be clearly inferred from FIGS. 3A to 3D.

In other words, the electrical charges are emitted and applied at the outer face of the material, namely, on the face of the material opposite the face of the same material which rests on, or is directed towards, the surface 12 supporting the material.

The electrical charges, in particular in the form of negative electrical charges, are denoted by reference “C”. The same reference “C” also denotes the electrical charges, preferably positive, acting on the side of the supporting surface 12, as described in more detail below.

Preferably, the means for emitting electrical charges operate before the material is conveniently processed, in particular before the material 11 is conveniently cut, and in any case after the same material has been laid out flat on the supporting surface 12.

As may be clearly inferred from FIGS. 1 and 2, the means 14 for emitting electrical charges are at the material 11, in particular when the same material is positioned on the surface 12 supporting the same material, especially defining the supporting surface of the material on which the cut is made.

More specifically, the means 14 for emitting electrostatic, or electrical, charges are positioned above the material 11, and in particular above the surface 12 supporting the same material 11.

More specifically, the means 14 for emitting electrostatic, or electrical, charges are spaced, more specifically spaced perpendicularly, from the material, and in particular are spaced, more specifically perpendicularly spaced, from the surface 12 supporting the same material 11.

Advantageously, the means 14 for emitting electrical charges extend parallel to the material 11, and in particular parallel to the surface 12 supporting the material 11.

As illustrated, the material 11 and/or the surface 12 supporting the same material 11 extend mainly along a longitudinal direction of extension of the apparatus.

Advantageously, the means 14 for emitting electrical charges extend transversely to the material 11 and/or to the surface 12 supporting the same material 11.

Advantageously, the means 14 for emitting electrical charges and the material 11, and/or the surface 12 supporting the same material 11, are movable relative to each other.

More specifically, the means 14 for emitting electrical charges are movable, in particular in a parallel fashion, with respect to the material 11 and/or to the surface 12 supporting the material.

More specifically, the means 14 for emitting electrical charges are movable longitudinally to the material 11 and/or to the surface 12 supporting the same material 11, as shown by the arrow F in FIG. 1.

More specifically, the surface 12 supporting the material 11 is defined by the upper face of a corresponding supporting sheet 13.

The supporting sheet 13, that is, the supporting surface 12, is preferably made of dielectric material, and preferably comprises glass, that is, it is made completely or mainly of glass.

Advantageously, the means designed to generate a field of electrostatic attraction of the material 11 on the supporting surface 12 also comprise means 16 designed to induce electrical charges on the surface 12 supporting the material 11.

Advantageously, the means designed to generate a field of electrostatic attraction of the material 11 on the supporting surface 12 comprise means 16 designed to induce a homogeneous distribution of electrical charges on the surface 12 supporting the material 11.

Advantageously, the means 16 designed to generate a field of electrostatic attraction of the material 11 on the supporting surface 12 comprise means designed to induce electrical charges below the surface 12 supporting the material, in particular below the sheet 13 defining the supporting surface 12.

Advantageously, the means designed to induce a charge at the supporting surface comprise means 16 made of electrically conductive material, in particular metallic material.

As illustrated, advantageously, the means made of electrically conductive material are positioned at, in particular below, the supporting surface 12, in particular below the sheet 13 defining the supporting surface 12.

Advantageously, the means 16 made of electrically conductive material are fixed relative to the supporting surface 12, in particular being integral with the sheet 13 defining the supporting surface 12.

Advantageously, the means 16 made of conductive material extend parallel to the surface 12 supporting the material, in particular parallel to the sheet 13 defining the surface supporting the material.

More specifically, the means made of material are in the form of a respective plate 16, preferably made of metal.

Advantageously, the means 16 made of electrically conductive material are in contact with the lower face of the sheet 13 defining the supporting surface 12, that is, with the face of the sheet 13 which is opposite the face of the sheet 13 which defines the surface 12 supporting the material 11.

Advantageously, there are means 17 designed to induce a static distribution of electrical charges in the means 16 made of electrically conductive material.

Advantageously, the means 16 made of electrically conductive material are in connection, by the electrical cable 171, with an earth 172, in such a way that a weak electrical current can be generated to earth, which is such as to induce a static distribution of electrical charges, in particular positive “C,” on the means made of an electrically conductive material.

This defines a corresponding and economically advantageous preferred embodiment of the means designed to induce a static distribution of electrical charges in the means 16 made of electrically conductive material.

To enable the material once processed, in particular cut, to be easily removed from the supporting surface 12, that is to say, conveniently processed without obstacles for subsequent processing, there are advantageous means 18 designed to neutralise an electrical charge which is present on the material 11, and more specifically, the electrical charge which has been previously induced or applied on the material.

Advantageously, the means designed to neutralise the electrical charge of the material 11 are in the form of de-ionizing means, and in particular in the form of a respective de-ionizing bar 18.

In particular, the de-ionizing bar 18 is in the form of a bar transversely elongate to the longitudinal direction of extension of the supporting surface 12 and of extension of the material 11 to be processed.

Advantageously, the means 18 designed to neutralise the electrical charge of the material 11 are at same material 11, in particular when the same material is positioned on the surface 12 supporting the same material, especially defining the supporting surface of the material on which the cut is made.

Advantageously, the means 18 designed to neutralise the electrical charge of the material 11 operate after the material has been conveniently processed, in particular after the material 11 has been conveniently cut.

More specifically, the means 18 designed to neutralise the electrical charge of the material 11 are above the material 11, in particular above the surface 12 supporting the same material 11.

As illustrated, the means 18 designed to neutralise the electrostatic, or electric, charge of the material 11 are spaced from the material 11, more specifically perpendicularly spaced from the material 11, and, according to another viewpoint, are spaced, more specifically perpendicularly spaced, from the surface 12 supporting the same material 11.

Advantageously, the means 18 designed to neutralise the electrical charge of the material 11 extend parallel to the material 11, in particular to the surface 12 supporting the same material 11.

Further advantageously, the means 18 designed to neutralise the electrical charge of the material 11 extend transversely to the material 11 and/or to the surface 12 supporting the same material 11.

Advantageously, the means 18 designed to neutralise the electrical charge of the material 11 and the material 11, and/or the surface 12 supporting the same material 11, are movable relative to each other.

Advantageously, the means 18 designed to neutralise the electrical charge of the material 11 are movable, in particular in a parallel fashion, with respect to the material 11 and/or to the surface 12 supporting the same material 11.

Advantageously, the means 18 designed to neutralise the electrical charge of the material 11 are movable longitudinally to the material 11 and/or to the surface 12 supporting the same material 11.

Advantageously, the means 18 designed to neutralise the electrical charge of the material 11 are movable together, in particular on same movable unit, with the means 14 for emitting the electrical charges, in particular on the material 11.

Advantageously, there are means for activating and deactivating the means 14 for emitting electrical charges.

Advantageously, there are also means for activating and deactivating the means 18 designed to neutralise the electrical charge of the material, more specifically operating in an alternating manner to the status of activating and deactivating the means 14 for emitting electrical charges.

Preferably, when the means 18 designed to neutralise the electrical charge of the material 11 and the means 14 for emitting the electrical charges on the material 11 are transported on the same movable unit, the means for activating and deactivating the means 14 for emitting electrical charges activate the emission of the charges during the step for feeding the material 11, as shown in FIGS. 3A to 3D. During this step, the means 18 for neutralizing the electrical charge are obviously deactivated. Next, upon completion of the cutting operation, the means for neutralizing the charge may be activated, during a corresponding movement of the movable unit relative to the material, with the means 14 for emitting electrical charges, which are, in a non-activated condition.

Advantageously, the apparatus comprises means 20 designed to convey the electrical charges “C” on the material 11.

In practice, advantageously, the apparatus according to the invention comprises means 20 designed to convey, or to transport, electrical charges.

Advantageously, the means 20 designed to convey the electrical charges, transport or convey the electrical charges on the material 11.

Preferably and advantageously, the means 20 designed to convey the electrical charges are in the form of means for blowing a corresponding flow of air towards the material 11 and/or towards the surface 12 supporting the material 11.

In practice, there are means 20 for blowing a flow of air towards the material 11 and/or towards the surface 12 supporting the material 11, which convey respective electrical charges.

Further advantageously, the means 20 designed to convey the electrical charges are in the form of an elongate blowing bar, or blade 20.

Advantageously, the means 20 designed to convey the electrical charges are at, or close to, the means 14 for emitting electrical charges, in such a way as to appropriately convey the electrical charges which are emitted from these means.

Advantageously, the means 20 designed to convey the electrical charges are at the material 11 positioned on the surface 12 supporting the material 11, in particular when the same material is positioned on the surface 12 supporting the same material, especially defining the supporting surface of the material on which the cut is made.

More specifically, the means 20 designed to convey the electrical charges are above the material, and/or above the surface 12 supporting the same material.

More specifically, the means 20 designed to convey the electrical charges are spaced from the material 11, more specifically perpendicularly spaced from the material 11, in particular being spaced, more specifically perpendicularly spaced, from the surface 12 supporting the same material 11.

Advantageously, the means 20 designed to convey the electrical charges extend parallel to the material 11, and/or to the surface 12 supporting the same material.

More specifically, the means 20 designed to convey the electrical charges extend transversely to the material 11, and/or to the surface 12 supporting the material 11.

Advantageously, the means 20 designed to convey the electrical charges on the material 11, and/or the surface 12 supporting the same material 11, are movable relative to each other.

Advantageously, the means 20 designed to neutralise the electrical charges are movable, in particular in a parallel fashion, with respect to the material 11 and/or to the surface 12 supporting the same material 11.

More specifically, the means 20 designed to neutralise the electrical charges are movable longitudinally to the material 11 and/or to the surface 12 supporting the same material 11.

Advantageously, the means 20 designed to convey the electrical charges are movable together with the means for emitting the electrical charge 14 and/or the means 18 designed to neutralise the electrical charge of the material, being carried in particular on the same movable unit as the means for emitting the electrical charge 14 and/or the means 18 designed to neutralise the electrical charge of the material.

Advantageously, there are means for activating and deactivating the means 20 designed to convey the electrical charges, which operate simultaneously and/or in accordance with the status of activating and deactivating the means 14 for emitting electrical charges. More specifically, when the means for emitting electrical charges are activated or deactivated, the means for conveying the electrical charges 20 are also activated or deactivated.

Advantageously, the cutting means used in this apparatus are movable together with, in particular on the same unit as, one or more of the means 20 designed to convey the electrical charges, the means 18 designed to neutralise the electrical charge of the material, and the means 14 for emitting electrical charges.

In practice, advantageously, one or more of the means 20 designed to convey the electrical charges, the means 18 designed to neutralise the electrical charges of the material, and the means 14 for emitting electrical charges are supported on the same movable cutting head of the material, the head supporting corresponding means for cutting the material, in particular of the rotary blade type. More specifically, when the cutting head comprises a pair of supporting rollers sliding on the product 11 and on the underlying supporting surface 12, the rollers being longitudinally spaced from each other and the cutting means extending between the rollers, and one or more of the means 20 designed to convey the electrical charges, the means 18 designed to neutralise the electrical charge of the material and the means 14 for emitting electrical charges, these can also extend between the supporting rollers sliding on the product and supporting surface 12.

As can be inferred from FIGS. 3A to 3D, according to a preferred procedure suitable for generating a convenient electrostatic field of attraction, an ionizing device 14 firstly moves above the material situated on the supporting surface 12 of the sheet 13, made of insulating or dielectric material, conveying the electrical charges, in particular negative, emitted by the ionizer 14 on the surface above the same material 11.

This achieves, due to the effect of the connection to earth of the means, or plate, 16 made of electrically conductive material, located below the supporting surface 12 or the sheet 13 for defining the supporting surface 12, the attraction of positive electrical charges at the upper surface of the conductor plate 16, with the generation of a corresponding weak electrical current towards the earth point 172.

After having processed, that is, cut, the material, the de-ionizing bar 18 may be passed over the material 11 and the material can be conveniently released and suitable processed downstream of the apparatus.

In practice, this provides an apparatus which is particularly effective and of limited cost, which is suitable for generating an advantageous and effective field of electrostatic attraction between the material to be processed, in particular to be cut, and the corresponding supporting surface of the material at the zone in which the material must be processed, that is, cut.

Advantageously, the dielectric or insulating supporting surface 12 might be made of any suitable and desired material, in particular a material which is different from glass, for example, it could be made from rubber or felt.

It is also possible that one or more of the means 20 designed to convey the electrical charges, the means for emitting the electrical charge 14 and the means 18 designed to neutralise the electrical charge of the material have an inclination different from the one illustrated in FIG. 2, that is, they are conveniently tilting, as shown by the corresponding two-way curved arrows of FIG. 2.

It is understood that although not particularly illustrated in the accompanying drawings, it is also imaginable that the apparatus comprises further means of processing material, in particular positioned on the supporting surface, especially in the form of means for forming reference points, or small holes, on the material or fabric and/or means for tracing lines, preferably defining shaped profiles of respective pieces and/or alphanumeric writing for identifying respective pieces on a corresponding material or sheet of paper, for example both as illustrated in patent application WO2014/132214, which is in the name of the same applicant, the description in that patent being incorporated herein by reference.

More specifically, the further means may be situated upstream, downstream and/or at the cutting zone of the material.

The invention described has evident industrial applications. It would be obvious to one skilled in the art that several changes and modifications can be made to the invention without departing from the spirit and scope of the invention, described in depth above. More specifically, one skilled in the art could easily imagine further embodiments of the invention comprising one or more of the features described herein. It will also be understood that all the details of the invention may be substituted by technically equivalent elements.

1-60. (canceled)

61. An apparatus (10) for processing, in particular for cutting, a material (11), the material preferably comprising a respective layer, especially in tape- or band-like form, preferably in the form of fabric or the like, and being especially for making corresponding pieces for clothing, that is, for garments, apparel, or the like; the apparatus having a respective surface (12) for supporting, in particular for resting, the material and, preferably, means for cutting the material, in particular located on the supporting surface (12); wherein it comprises means designed to generate a field of electrostatic attraction of the material (11) on the supporting surface (12).

62. The apparatus according to claim 61, wherein the means designed to generate a field of electrostatic attraction of the material on the supporting surface comprise means designed to induce electrical charges on the material (11).

63. The apparatus according to claim 62, wherein the means designed to induce electrical charges on the material (11) homogeneously distribute electrical charges on the material (11).

64. The apparatus according to claim 61, wherein there are means (14) for emitting electrical charges, in particular defining the means designed to induce the electrical charges on the material (11).

65. The apparatus according to claim 64, wherein the means for emitting electrical charges comprise a respective ionizing bar (14).

66. The apparatus according to claim 61, wherein the electrical charges are applied at the outer face of the material, that is, on the face opposite the face which rests on, or which faces towards, the surface (12) for supporting the material.

67. The apparatus according to claim 64, wherein the means (14) for emitting electrical charges are at the material (11) positioned on the surface (12) supporting the same material.

68. The apparatus according to claim 64, wherein the means (14) for emitting electrical charges are positioned above the material, in particular above the surface (12) supporting the same material.

69. The apparatus according to claim 64, wherein the means (14) for emitting electrical charges are spaced, more specifically perpendicularly spaced, from the material (11) and/or from the surface (12) supporting the same material.

70. The apparatus according to claim 64, wherein the means (14) for emitting electrical charges extend parallel to the material (11), in particular to the surface (12) supporting the same material.

71. The apparatus according to claim 64, wherein the material (11) and/or the surface (12) supporting the material extend mainly along a longitudinal direction of extension of the apparatus; the means (14) for emitting electrical charges extending transversely to the material (11) and/or to the surface (12) supporting the material.

72. The apparatus according to claim 64, wherein the means (14) for emitting electrical charges and the material (11), and/or the surface (12) supporting the same material (11), are movable relative to each other.

73. The apparatus according to claim 64, wherein the means (14) for emitting electrical charges are movable, in particular in a parallel fashion, with respect to the material (11) and/or to the surface (12) supporting the same material (11).

74. The apparatus according to claim 64, wherein the means (14) for emitting electrical charges are movable longitudinally to the material (11) and/or to the surface (12) supporting the same material (11).

75. The apparatus according to claim 64, wherein there are means for activating and deactivating the means (14) for emitting electrical charges.

76. The apparatus according to claim 61, wherein the surface (12) for supporting the material is defined by the upper face of a corresponding supporting sheet (13).

77. The apparatus according to claim 76, wherein the supporting surface or sheet (13) is made of a dielectric material, preferably comprising or being made of glass.

78. The apparatus according to claim 61, wherein the means designed to generate a field of electrostatic attraction of the material (11) on the supporting surface (12) comprise means (16) designed to induce electrical charges on the surface (12) supporting the material.

79. The apparatus according to claim 78, wherein the means designed to generate a field of electrostatic attraction of the material (11) on the supporting surface (12) comprise means (16) designed to induce a homogeneous distribution of electrical charges on the surface (12) supporting the material.

80. The apparatus according to claim 78, wherein the means designed to generate a field of electrostatic attraction of the material (11) on the supporting surface (12) comprise means (16) designed to induce electrical charges below the surface (12) supporting the material, in particular below the sheet (13) defining the supporting surface (12).

81. The apparatus according to claim 78, wherein the means designed to induce an electrical charge at the supporting surface comprise means (16) made of electrically conductive material, in particular metallic material.

82. The apparatus according to claim 81, wherein the means (16) made of electrically conductive material are positioned at, in particular below, the supporting surface (12), in particular below the sheet or plane (13) defining the supporting surface (12).

83. The apparatus according to claim 81, wherein the means (16) made of electrically conductive material are fixed relative to the supporting surface (12), in particular being integral with the sheet, or plane, (13) defining the supporting surface (12).

84. The apparatus according to claim 81, wherein the means (16) made of electrically conductive material extend parallel to the surface (12) supporting the material, in particular parallel to the sheet (13) defining the supporting surface of the material (12).

85. The apparatus according to claim 81, wherein the means (16) made of electrically conductive material are in the form of a respective plate (16), preferably made of metal.

86. The apparatus according to claim 81, wherein the means (16) made of electrically conductive material are in contact with the lower face of the sheet, or plane, (13) defining the supporting surface (12), that is, with the face of the sheet, or plane, (13) opposite the one defining the supporting surface (12).

87. The apparatus according to claim 81, wherein there are means (17) designed to induce a static distribution of electrical charges in the means (16) made of electrically conductive material.

88. The apparatus according to claim 81, wherein the means (16) made of electrically conductive material are in connection (171) with an earth (172).

89. The apparatus according to claim 61, wherein it comprises means (18) designed to neutralise an electrical charge on the material (11).

90. The apparatus according to claim 89, wherein the means designed to neutralise the electrical charge of the material (11) are in the form of de-ionizing means (18), in particular in the form of a respective de-ionizing bar (18).

91. The apparatus according to claim 61, further comprising means (20) designed to convey electrical charges on the material (11), and wherein there are means for blowing a flow of air towards the material (11) and/or towards the surface (12) for supporting the material (11) for conveying respective electrical charges.

92. The apparatus according to claim 61, wherein the means (20) for cutting the material are movable together, in particular on the same movable unit, with one or more of the means (20) designed to convey the electrical charges, means (18) designed to neutralise the electrical charge and means for emitting electrical charges.
